(19) United States
(12) Patent Application Publication
(10) Pub. No.: US 2015/0239493 A1
(43) Pub. Date: Aug. 27, 2015

(54) BALL SCREW AND STEERING APPARATUS

(71) Applicant: Showa Corporation, Gyoda-shi (JP)

(72) Inventor: Ryota ITO, Haga-gun (JP)

(73) Assignee: SHOWA CORPORATION, Gyoda-shi (JP)

(21) Appl. No.: 14/340,747

(22) Filed: Jul. 25, 2014

(30) Foreign Application Priority Data
Feb. 26, 2014 (JP) 2014-034821

(51) Int. Cl. B62D 5/04; B62D 3/08

(52) U.S. Cl. CPC B62D 5/0448; B62D 3/08

(57) ABSTRACT

A ball screw includes: a nut; a screw shaft; and an end deflector that is attached to the nut, and has a guiding protrusion portion which protrudes toward a helical groove of the screw shaft, in which a guiding tip edge of the guiding protrusion portion picks up a ball and guides the ball into the end deflector, the end deflector includes a ball lifting portion that lifts the ball along one groove side surface of the helical groove, and the guiding tip edge picks up the ball lifted by the ball lifting portion.

### CROSS-REFERENCE TO RELATED APPLICATIONS

This application is based on and claims priority under 35 USC 119 from Japanese Patent Application No. 2014-034821 filed on Feb. 26, 2014, the entire content of which is incorporated herein by reference.

### BACKGROUND OF THE INVENTION

1. Technical Field

The present invention relates to a ball screw and a steering apparatus.

2. Related Art

There is a method in which an end deflector is adopted so as to circulate a ball screw. In this method, a circulation path is formed in a nut so as to circulate a ball. The end deflector is attached to each end of the nut so as to guide the ball to the circulation path from the nut and a helical groove of a screw shaft, or to return the ball to the helical groove from the circulation path (refer to Patent Literature 1 (JP-A-2012-154437)). The end deflector has a guiding protrusion portion (a claw in Patent Literature 1) that protrudes into the helical groove of the screw shaft so as to pick up the ball into the end deflector.

### SUMMARY OF THE INVENTION

Since the screw shaft is a moving body, a gap is provided between the guiding protrusion portion and the helical groove of the screw shaft so as to prevent interference between the guiding protrusion portion and the screw shaft. That is, there is a problem in that a step is formed between the guiding protrusion portion and the helical groove of the screw shaft, and thus collision noise occurs when the ball comes out of the helical groove of the screw shaft, and is brought into contact with the step.

The present invention is made so as to solve the problem. An object of the present invention is to provide a ball screw and a steering apparatus in which an end deflector and a ball can be prevented from making collision noise when the ball enters the end deflector from a helical groove of a screw shaft.

A ball screw according to an aspect of the present invention includes a nut; a screw shaft; and an end deflector that is attached to the nut, and has a guiding protrusion portion which protrudes toward a helical groove of the screw shaft. A guiding tip edge of the guiding protrusion portion picks up a ball and guides the ball into the end deflector. The end deflector includes a ball lifting portion that lifts the ball along one groove side surface of the helical groove. The guiding tip edge picks up the ball lifted by the ball lifting portion.

In this ball screw, when the ball lifting portion lifts the ball from the helical groove of the screw shaft, a gap is formed between the ball and the helical groove of the screw shaft. The guiding tip edge picks up the ball from this state, and thus it is possible to avoid the collision of the ball with the guiding tip edge and to prevent the occurrence of collision noise. Even when the ball collides with the guiding tip edge, the ball collides with the guiding tip edge at a shallow angle (an angle at which a forward moving direction of the ball intersects a direction tangential to a colliding portion of the ball) to the extent that the ball is lifted. Accordingly, it is possible to reduce collision noise.

The ball screw according to the aspect of the present invention, may have a configuration in which the one groove side surface is a groove side surface that is positioned on an outer side of the screw shaft in an axial direction thereof.

The ball screw according to the aspect of the present invention, may have a configuration in which a portion of the guiding tip edge close to the other groove side surface protrudes toward an opposite direction of a forward moving direction of the ball further than a portion of the guiding tip edge close to the one groove side surface in such a manner that the guiding tip edge starts picking up the ball from a position which is separated from the other groove side surface by using a gap formed between the ball lifted by the ball lifting portion and the other groove side surface of the helical groove.

A steering apparatus according to another aspect of the present invention includes the ball screw, and a motor. The motor rotates the nut so as to move the screw shaft in an axial direction thereof.

In this steering apparatus, the end deflector and the ball can be prevented from making collision noise when the ball enters the end deflector from the helical groove of the screw shaft.

According to the aspects of the present invention, the end deflector and the ball can be prevented from making collision noise when the ball enters the end deflector from the helical groove of the screw shaft.

### BRIEF DESCRIPTION OF THE DRAWINGS

FIG. 1 is a schematic configuration view illustrating an example of a steering apparatus.

FIG. 2 is a cross-sectional view illustrating a helical groove of a nut and a helical groove of a screw shaft.

FIG. 3 is an exterior view of a ball screw according to the present invention, and illustrating a state where an end deflector is assembled with the nut (the screw shaft is not illustrated).

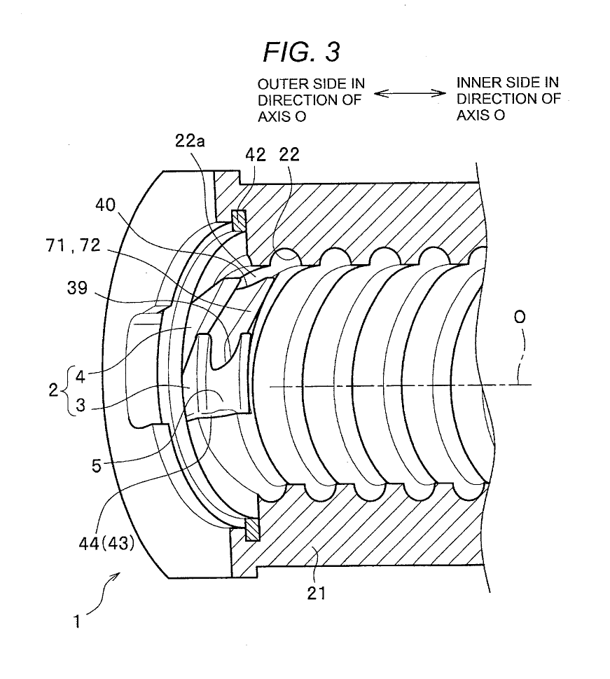

FIG. 4 is an exterior view of the ball screw according to the present invention, and illustrating a state where the end deflector is not assembled with the nut (the screw shaft is not illustrated).

FIGS. 5A to 5C illustrate views for description of the end deflector. FIG. 5A is a perspective view illustrating a state where a first member and a second member are assembled together, FIG. 5B is a perspective view illustrating a state where the first member and the second member are not assembled together, and FIG. 5C is a plan view illustrating a state where the first member and the second member are assembled together.

FIG. 6 is a plan view of the nut and the end deflector when seen in an axial direction of the screw shaft.

FIG. 7 is a cross-sectional view of the helical groove of the screw shaft and the second member of the end deflector.

FIGS. 8A to 8D are cross-sectional views illustrating an operation in which a ball is lifted along one groove side surface by a ball lifting portion.

FIG. 9 is a plan development view of the helical groove of the screw shaft when seen in a radial direction.

### DETAILED DESCRIPTION OF THE INVENTION

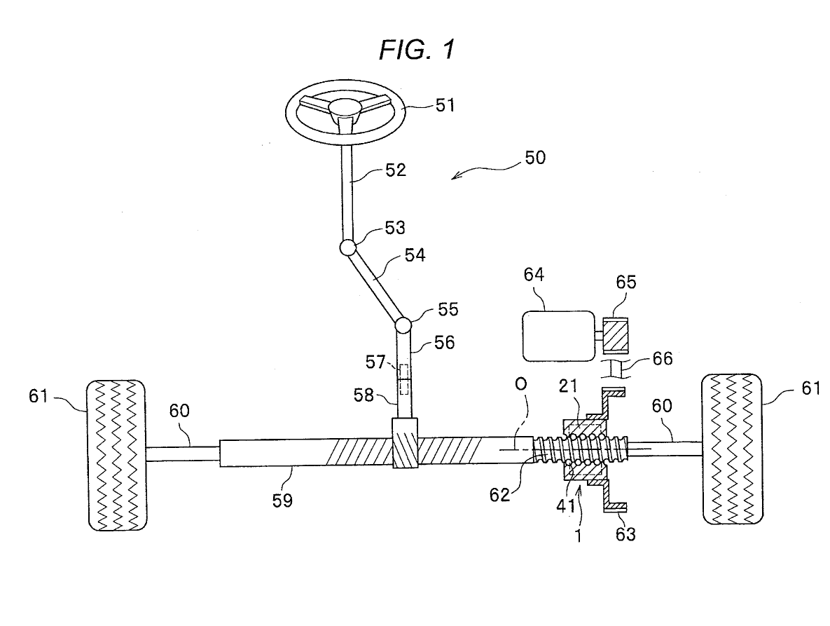

As illustrated in FIG. 1, for example, a ball screw 1 of the present invention is used in a rack assist power steering apparatus 50. The power steering apparatus 50 as an example includes a steering wheel 51 that is operated by a driver; a steering shaft 52 that is integrally connected to the steering wheel 51; an upper connection shaft 54 connected to the steering shaft 52 via a universal coupling 53; a lower connection shaft 56 connected to the upper connection shaft 54 via a universal coupling 55; a pinion shaft 58 that is connected to the lower connection shaft 56 via a torsion bar 57, and has a pinion in a lower portion; and a rack shaft 59 that has rack teeth meshing with the pinion, and is connected to right and left front wheels 61 via a tie rod 60 at each end. The rack shaft 59 functions as a turning shaft for turning of a tire wheel.

A screw shaft 62 between the rack shaft 59 and one of the tie rods 60 is integrally attached to the rack shaft 59, and the ball screw 1 is attached to the screw shaft 62. A driven pulley 63 is turnably attached to an outer circumference of a nut 21 of the ball screw 1, and a drive pulley 65 is turnably attached to an output shaft of an assist electric motor 64, A transmission belt 66 is wound around between the drive pulley 65 and the driven pulley 63.

In the power steering apparatus 50 with the aforementioned configuration, a torque exerted on the steering wheel 51 is detected by a torque sensor which is not illustrated, and a control device which is not illustrated controls driving of the motor 64 based on the detected torque. Accordingly, a torque generated by the motor 64 is transmitted to the rack shaft 59 via a transmission mechanism having the drive pulley 65, the transmission belt 66, and the driven pulley 63, and via the ball screw 1. The generated torque functions as an auxiliary force for an operation force which the driver exerts on the steering wheel 51.

The ball screw 1 of the present invention is applicable to a so-called steer-by-wire steering apparatus in which a reactive force actuator giving operation feeling to the driver during the operation of the steering wheel is electrically connected to a turning actuator having a motor for driving of the turning shaft. In the steer-by-wire steering apparatus, the screw shaft 62 is integrally attached to the turning shaft.

Hereinafter, the ball screw 1 will be described in detail.

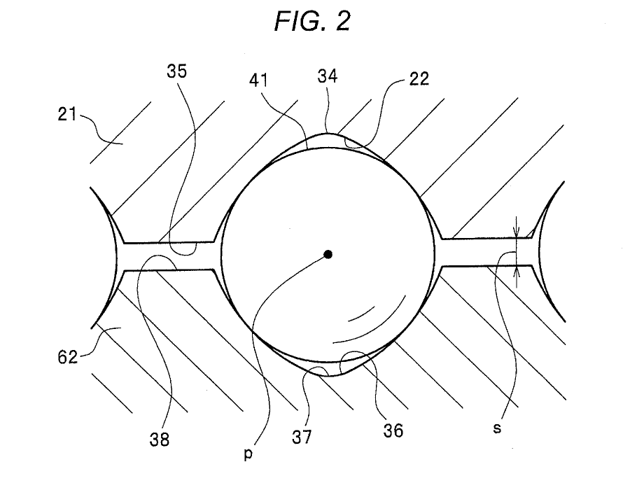

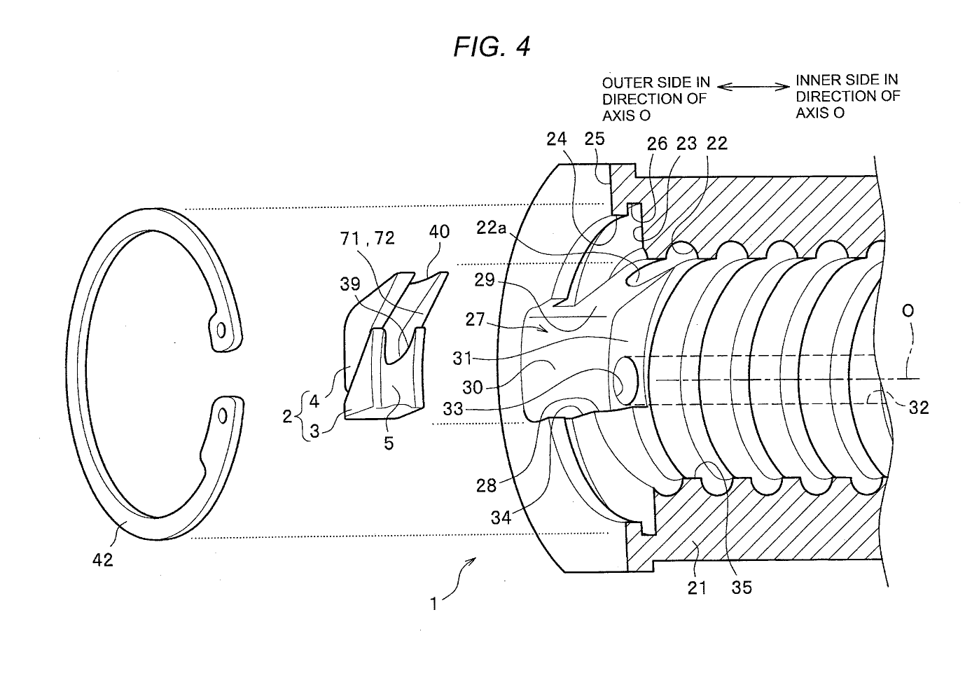

In FIG. 4, the ball screw 1 is configured to include the nut 21; the screw shaft 62 (refer to FIG. 1) that is inserted into the nut 21; a ball 41 (refer to FIG. 2); and an end deflector 2 that is attached to the nut 21. In the following description, a forward moving direction of the ball 41 indicates a direction in which the ball 41 enters the end deflector 2 from helical grooves 22 and 36.

### Nut 21

As illustrated in FIG. 2, the nut 21 is a cylindrical member, and includes the helical groove 22 that accommodates the ball 41 between the helical groove 36 of the screw shaft 62 and the helical groove 22. For example, each of the helical grooves 22 and 36 has a cross-sectional shape of a Gothic arc, and has groove bottom portions 34 and 37, respectively. A groove top portion 35 of the helical groove 22 is separated from a groove top portion 38 of the helical groove 36 by a distance s.

In FIG. 4, a circumferential end portion of the nut 21 has a step shape, and has an annular inner end surface 23 that is formed in a circumferential edge of an opening portion into which the screw shaft 62 is inserted; a stepped wall surface 24 that is formed so as to protrude toward an outer side in a direction of an axis O of the screw shaft 62 from an outer edge of the inner end surface 23; and an annular outer end surface 25 that is formed in a radial direction with respect to the axis O from an outer end of the stepped wall surface 24. The groove 26 is formed over the entire circumferential surface of the stepped wall surface 24 so as to lock a snap ring 42 which will be described later. The outer side in the direction of the axis O indicates a direction in which a portion becomes far away along the direction of the axis O from a center portion of the direction of the axis O of the nut 21. An inner side in the direction of the axis O indicates a direction in which a portion becomes close to the center portion of the direction of the axis O of the nut 21.

An accommodation portion 27 for accommodation of the end deflector 2 is formed by cutting the end portion of the nut 21 off from the outer end surface 25 and the inner end surface 23 toward the inner side in the direction of the axis O. The accommodation portion 27 is partitioned by a first side wall surface 28 and a second side wall surface 29 which are formed from an inner circumferential surface to an outer circumferential surface of the nut 21 so as to face each other; a bottom wall surface 30 that is formed across from an end portion of the first side wall surface 28 close to the outer circumferential surface of the nut 21 to an end portion of the second side wall surface 29 close to the outer circumferential surface of the nut 21; and a contact surface 31 that is formed across end portions of the first side wall surface 28, the second side wall surface 29, and the bottom wall surface 30, which are close to the inner side in the direction of the axis O.

The first side wall surface 28, the second side wall surface 29, and the bottom wall surface 30 are formed along the direction of the axis O, and the contact surface 31 is formed along a plane orthogonal to the direction of the axis O. The first side wall surface 28 and the second side wall surface 29 face each other, and are not required to be in parallel with each other. In the embodiment, the first side wall surface 28 is formed so as to incline outwardly in the radial direction with respect to the axis O. The second side wall surface 29 is formed so as to incline outward in the radial direction with respect to the axis O further than the first side wall surface 28. The second side wall surface 29 is formed so as to be smoothly joined to an end portion 22a of the helical groove 22. An opening portion 33 of a circulation path 32 is present in the contact surface 31. The circulation path 32 is formed along the direction of the axis O of the nut 21, and another opening 33 is formed in an opposite end portion of the nut 21.

### End Deflector 2

The end deflector 2 straightens out a helical movement of the balls 41 (refer to FIG. 2) in the helical grooves 22 and 36, and movement of the balls 41 in the circulation path 32 in the direction of the axis O. That is, the end deflector 2 is a member that enables the balls 41 to move back and forth between the helical grooves 22 and 36 and the circulation path 32. The end deflector 2 has a guiding protrusion portion 5 protruding toward the helical groove 36 of the screw shaft 62.

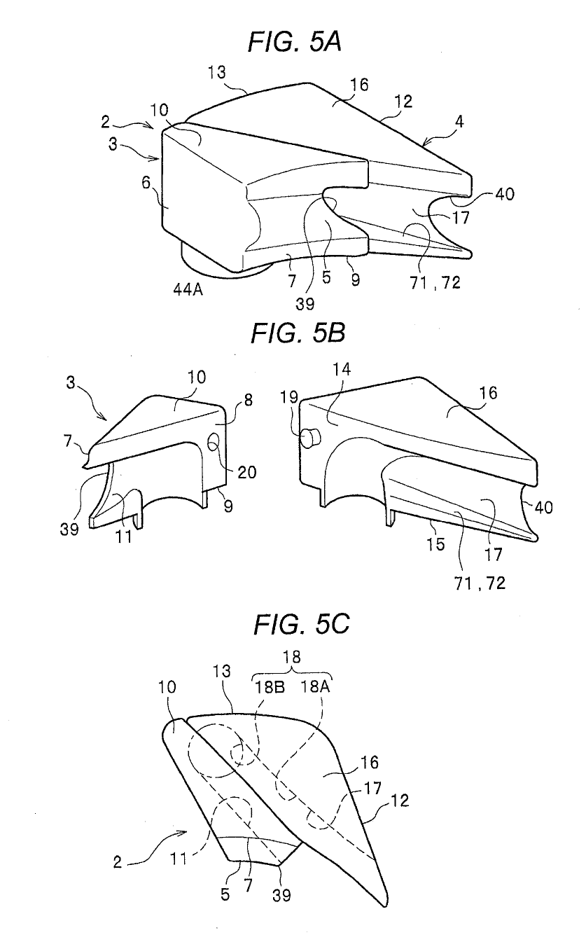

In FIGS. 5A to 5C, a path 18 is formed inside the end deflector 2 so as to allow the ball 41 to pass therethrough. Mainly from the viewpoint of moldability of the path 18, the end deflector 2 is formed of two split members (a first member 3 and a second member 4). A material of the end deflector 2 is not particularly limited, and the end deflector 2 may be made of a metallic material, a synthetic resin material, or the like. For example, when the end deflector 2 is made of a zinc material, the components of the end deflector 2 can be formed using a die casting method.

The first member 3 has a first side surface 6 that is an outer contour surface formed approximately along the direction of the axis O so as to face the first side wall surface 28; an inner surface 7 that faces the screw shaft 62; and a splitting surface 8 that is in surface contact with the second member 4. The first member 3 has a substantially triangular shape when seen in the direction of the axis O. An end surface of the first member 3 close to the inner side in the direction of the axis O is formed of a contacted surface 9 that is in contact with the contact surface 31. An end surface of the first member 3 close to the outer side in the direction of the axis O is formed of an end surface 10 that is pressed by the snap ring 42. A first half spherical path 11 of a substantially half spherical cross-sectional shape is formed on the splitting surface 8 so as to form the path 18 for the ball 41 when the first member 3 is assembled with the second member 4. The first half spherical path 11 is a path which is present in the helical groove 36 of the screw shaft 62.

### Guiding Protrusion Portion 5

The guiding protrusion portion 5 is formed on a part of the inner surface 7 of the first member 3 so as to bulge inward in the radial direction and to be positioned in the helical groove 36 of the screw shaft 62. The guiding protrusion portion 5 has a substantially half spherical shape, and has a size such that the guiding protrusion portion 5 does not interfere with the helical groove 36 of the screw shaft 62. A tip edge 39 (an edge portion that faces the ball 41 moving toward the end deflector 2, and an opening edge portion of the first half spherical path 11 which is present in the helical groove 36 of the screw shaft 62) of the guiding protrusion portion 5 picks up the balls 41, and guides the balls into the end deflector 2.

The second member 4 has a second side surface 12 that is an outer contour surface formed approximately along the direction of the axis O so as to face the second side wall surface 29; an outer surface 13 that faces the bottom wall surface 30; and a splitting surface 14 that is in surface contact with the first member 3. The second member 4 has a substantially triangular shape when seen in the direction of the axis O. An end surface of the second member 4 close to the inner side in the direction of the axis O is formed of a contacted surface 15 that is in contact with the contact surface 31. An end surface of the second member 4 close to the outer side in the direction of the axis O is formed of an end surface 16 that is pressed by the snap ring 42. A second half spherical path 17 of a substantially half spherical cross-sectional shape is formed on the splitting surface 14 of the second member 4 so as to form the path 18 for the ball 41 when the second member 4 is assembled with the first member 3. The second half spherical path 17 is a path which is present in the helical groove 22 of the nut 21. A notch 40 is formed at a tip end of the second half spherical path 17 so as to smoothly guide the balls 41 from the end portion 22a of the helical groove 22.

An engaging protrusion portion 19 is formed on the splitting surface 14 of the second member 4, and an engaging concave portion 20 is formed in the splitting surface 8 of the first member 3. For example, when snap engagement of the engaging protrusion portion 19 with the engaging concave portion 20 is performed, the splitting surface 8 is brought into surface contact with the splitting surface 14, the first member 3 and the second member 4 are integrated together, and thus the end deflector 2 is formed. The end surfaces 10 and 16 are joined together, and are flush with each other, and the contacted surfaces 9 and 15 are joined together, and are flush with each other. When the first half spherical path 11 and the second half spherical path 17 are combined together inside the end deflector 2, the path 18 is formed of a first path 18A and a second path 18B. The first path 18A is formed so as to communicate the helical groove 22 of the nut 21 with the helical groove of the screw shaft 62. The second path 18B smoothly changes its direction at substantially 90 degrees from the first path 18A so as to be formed along the direction of the axis O, and communicates with the opening portion 33 of the circulation path 32. A method of integrating the first member 3 with the second member 4 is not particularly limited to the method of engaging the engaging protrusion portion 19 with the engaging concave portion 20. A structure in which the first member 3 and the second member 4 are not integrated together may be adopted.

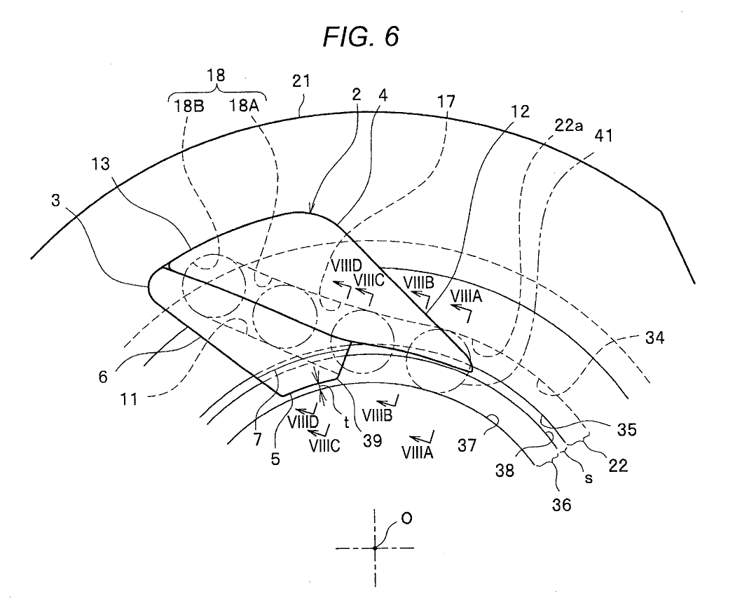

In the aforementioned configuration, as illustrated in FIG. 6, when the ball 41 enters the end deflector 2, the ball 41 goes through the following states in sequence:

(1) a state where the ball 41 is interposed between the helical groove 36 of the screw shaft 62 and the helical groove 22 of the nut 21

(2) a state where the ball 41 is interposed between the helical groove 36 of the screw shaft 62 and the second half spherical path 17 of the second member 4

(3) a state where the ball 41 is interposed between the first half spherical path 11 of the first member 3 and the second half spherical path 17 of the second member 4

When the second half spherical path 17 of the second member 4 smoothly communicates with the end portion 22a of the helical groove 22 of the nut 21 without a gap or a step therebetween, the ball 41 can move smoothly during the state transition of the ball 41 from (1) to (2). However, the screw shaft 62 is a moving body that moves relative to the end deflector 2, and thus it is not possible to avoid setting of a gap t for prevention of contact between the guiding tip edge 39, a starting point of the first half spherical path 11, and the helical groove 36 of the screw shaft 62 during the state transition of the ball 41 from (2) to (3). Accordingly, in the related art, there is a problem in that the ball 41 collides with the guiding tip edge 39 due to the presence of the gap t, thereby causing collision noise.

### Ball Lifting Portion 71

As illustrated in FIGS. 5A, 5B, 7, and 8A to 8D, with regard to the aforementioned problem, the end deflector 2 of the present invention includes a ball lifting portion 71 that lifts the ball 41 along one groove side surface 75A of the helical groove 36 of the screw shaft 62. The guiding tip edge 39 picks up the ball 41 lifted by the ball lifting portion 71. In the embodiment, one groove side surface 75A indicates a groove side surface which is positioned on the outer side in the direction of the axis O. “One groove side surface 75A” indicates a side surface of the helical groove 36, which is formed on one side with a base of the groove bottom portion 37 (refer to FIG. 2) as a boundary reference, and “the other groove side surface 75B” is a side surface of the helical groove 36, which is formed on the other side with the groove bottom portion 37 as the boundary reference.

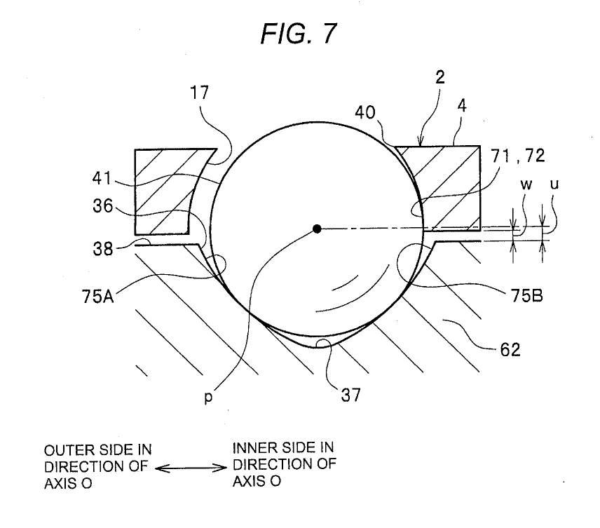

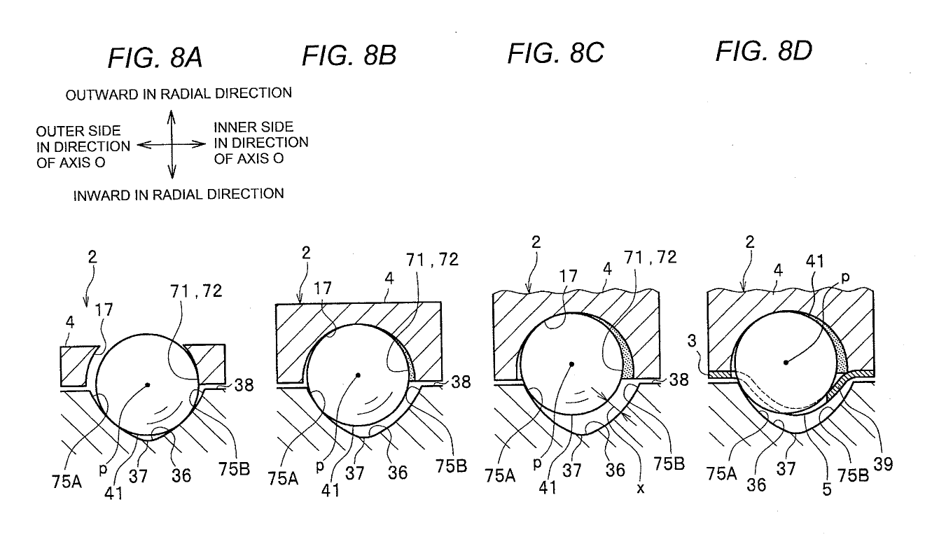

In an inner circumferential wall of the second half spherical path 17 of the second member 4, the ball lifting portion 71 is formed of an inclined lifting wall 72 that inclines toward the forward moving direction of the ball 41 so as to be close to the groove side surface 75A of the helical groove 36 of the screw shaft 62. In FIGS. 8A to 8D, a region, in which the inclined lifting wall 72 is displaced, is illustrated by a stipple method so as to easily understand a state where the inclined lifting wall 72 is displaced so as to be gradually closer to the groove side surface 75A. FIGS. 8A and 7 are cross-sectional views taken at a position in which the notch 40 (refer to FIGS. 5A and 5B) is formed.

As illustrated in FIGS. 8A to 8D, the inclined lifting wall 72 may have a curved surface so as to follow the shape of the ball 41, or may have a flat surface according to circumstances. As illustrated in FIG. 7, a distance w between the groove top portion 38 of the screw shaft 62 and the inclined lifting wall 72 is set to be smaller than a distance u between the groove top portion 38 of the screw shaft 62 and a ball center p. That is, since an inner edge in the radial direction of the inclined lifting wall 72 is positioned inwardly in the radial direction further than the ball center p, the inclined lifting wall 72 pushes an inner portion in the radial direction of the ball 41. Accordingly, the inclined lifting wall 72 pushes the ball 41 outwardly in the direction of the axis O and at least along the direction of the axis O. A portion of the inclined lifting wall 72, which is positioned inwardly in the radial direction further than the ball center p, inclines in the radial direction so as to efficiently push the ball 41 in the radial direction.

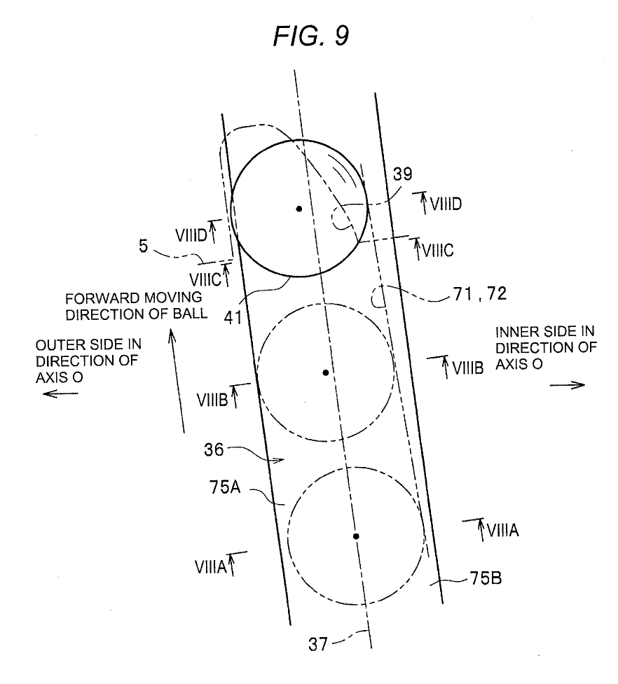

Since the ball 41 is lifted along one groove side surface 75A, the ball 41 is separated from the other groove side surface 75B. Accordingly, as illustrated in FIG. 8C, a gap x is formed between the ball 41 and the groove side surface 75B. As illustrated in FIG. 9, in the embodiment, a portion of the guiding tip edge 39 close to the other groove side surface 75B protrudes in an opposite direction of the forward moving direction of the ball further than a portion of the guiding tip edge 39 close to one groove side surface 75A in such a manner that the guiding tip edge 39 starts picking up the ball 41 from a position separated from the groove side surface 75B by the gap x. That is, the guiding tip edge 39 has a notched shape in which the portion thereof close to the other groove side surface 75B is positioned to be closer to the forward moving direction of the ball than the portion thereof close to one groove side surface 75A. In the embodiment, the guiding tip edge 39 inclines from the portion of the guiding tip edge 39 close to one groove side surface 75A to the portion thereof close to the other groove side surface 75B so as to be positioned in the opposite direction of the forward moving direction of the ball.

### Operation

When the ball 41 enters the second half spherical path 17 of the second member 4 during the state transition of the ball 41 from (1) to (2) described above, as illustrated in FIGS. 8A, 8B, and 8C, the ball 41 is lifted along one groove side surface 75A of the helical groove 36 by the inclined lifting wall 72. The gap x is formed between the ball 41 and the other groove side surface 75B. FIGS. 8A to 8D illustrate cross-sectional views approximately taken along line VIIIA-VIIIA, line VIIIB-VIIIB, line VIIIC-VIIIC, and line VIIID-VIIID, respectively, in FIGS. 6 and 9.

When the predetermined gap x is formed, as illustrated in FIG. 8D, the ball 41 is picked up by the guiding tip edge 39. As known from FIG. 9, the portion of the guiding tip edge 39 close to the other groove side surface 75B is positioned so as to protrude toward the opposite direction of the forward moving direction of the ball further than the portion of the guiding tip edge 39 close to one groove side surface 75A. As illustrated in FIG. 8D, the portion of the guiding tip edge 39 close to the other groove side surface 75B is positioned so as to be separated from the groove side surface 75B by the gap x. Accordingly, the portion of the guiding tip edge 39 close to the other groove side surface 75B starts picking up the ball 41 without the ball 41 colliding with the guiding tip edge 39, and the ball 41 enters the first half spherical path 11 of the first member 3. Since the ball 41 gradually rides on the first half spherical path 11, the ball 41 does not collide with the portion of the guiding tip edge 39 close to one groove side surface 75A.

In the aforementioned configuration, the ball lifting portion 71 is formed in the end deflector 2 so as to lift the ball 41 along one groove side surface 75A of the helical groove 36 of the screw shaft 62, the guiding tip edge 39 picks up the lifted ball 41, and thus it is possible to avoid the collision of the ball 41 with the guiding tip edge 39. Even when the ball 41 collides with the guiding tip edge 39, the ball 41 collides with the guiding tip edge 39 at a shallow angle to the extent that the ball 41 is lifted. Accordingly, it is possible to reduce collision noise.

In the simple configuration in which the portion of the guiding tip edge 39 close to the other groove side surface 75B protrudes toward the opposite direction of the forward moving direction of the ball further than the portion of the guiding tip edge 39 close to one groove side surface 75A in such a manner that the guiding tip edge 39 starts picking up the ball 41 from a position separated from the groove side surface 75B by the gap x, it is possible to avoid the collision of the ball 41 with the guiding tip edge 39, and to prevent the occurrence of collision noise.

### MODIFICATION EXAMPLE

In the embodiment, the groove side surface positioned on the outer side in the direction of the axis O functions as one groove side surface 75A along which the ball 41 is lifted. In contrast, the groove side surface positioned on the inner side in the direction of the axis O may function as one groove side surface 75A. In this case, the path 18 of the end deflector 2 is formed in such a manner that the first path 18A is joined with the second path 18B while inclining toward the inner side in the direction of the axis O.

What is claimed is:

1. A ball screw comprising:
a nut;
a screw shaft; and
an end deflector that is attached to the nut, and has a guiding protrusion portion which protrudes toward a helical groove of the screw shaft,
wherein a guiding tip edge of the guiding protrusion portion picks up a ball and guides the ball into the end deflector,
the end deflector includes a ball lifting portion that lifts the ball along one groove side surface of the helical groove, and
the guiding tip edge picks up the ball lifted by the ball lifting portion.

2. The ball screw according to claim 1,
wherein the one groove side surface is a groove side surface that is positioned on an outer side of the screw shaft in an axial direction thereof.

3. The ball screw according to claim I,
wherein a portion of the guiding tip edge close to the other groove side surface protrudes toward an opposite direction of a forward moving direction of the ball further than a portion of the guiding tip edge close to the one groove side surface in such a manner that the guiding tip edge starts picking up the ball from a position which is separated from the other groove side surface by using a gap formed between the ball lifted by the ball lifting portion and the other groove side surface of the helical groove.

4. The ball screw according to claim 2,
wherein a portion of the guiding tip edge close to the other groove side surface protrudes toward an opposite direction of a forward moving direction of the ball further than a portion of the guiding tip edge close to the one groove side surface in such a manner that the guiding tip edge starts picking up the ball from a position which is separated from the other groove side surface by using a gap formed between the ball lifted by the ball lifting portion and the other groove side surface of the helical groove.

5. A steering apparatus comprising:
the ball screw according to claim 1; and
a motor,
wherein the motor rotates the nut so as to move the screw shaft in an axial direction thereof.

6. A steering apparatus comprising:
the ball screw according to claim 2; and
a motor,
wherein the motor rotates the nut so as to move the screw shaft in the axial direction thereof.

7. A steering apparatus comprising:
the ball screw according to claim 3; and
a motor,
wherein the motor rotates the nut so as to move the screw shaft in an axial direction thereof.

8. A steering apparatus comprising:
the ball screw according to claim 4; and
a motor,
wherein the motor rotates the nut so as to move the screw shaft in the axial direction thereof.
